(19) United States
(12) Patent Application Publication
(10) Pub. No.: US 2019/0239597 A1
(43) Pub. Date: Aug. 8, 2019

(54) EYELET MACHINE

(71) Applicant: Nian-Hao Liao, Taichung City (TW)

(72) Inventor: Nian-Hao Liao, Taichung City (TW)

(21) Appl. No.: 15/890,122

(22) Filed: Feb. 6, 2018

(51) Int. Cl. A43D 100/02; F16B 2/06

(52) U.S. Cl. CPC A43D 100/02; F16B 2/065

(57) ABSTRACT

An eyelet machine includes a frame, a lower mold, a threaded rod, an upper mold and a bearing assembly. The frame includes a lower beam, an upper beam, and a post formed between the lower and upper beams. The lower mold is adapted for carrying a first washer of an eyelet and supported on the lower beam in a detachable manner. The threaded rod is connected to the upper beam so that the threaded rod is translatable relative to the upper beam when they are rotated relative to each other. The upper mold is adapted for carrying a second washer of the eyelet and connected to the threaded rod in a detachable manner so that they are translatable together. The bearing assembly is provided between the threaded rod and the upper mold and adapted for taking a load along an axis of the threaded rod.

### BACKGROUND OF INVENTION

### 1. Field of Invention

The present invention relates to an eyelet and, more particularly, to an eyelet machine.

### 2. Related Prior Art

As disclosed in Taiwanese Patent No. M297178, an eyelet machine includes a mold 20 and a presser 30. A positioning rod 22 extends from an upper face of mold 20. An annular concave face 211 is made in the upper face of mold 20. Annular concave face 211 extends around positioning rod 22. Presser 30 includes a cavity 31 in a lower end. An annular concave face 32 is formed at the lower end of presser 30. Annular concave face 32 extends around cavity 31. An eyelet 10 includes a tubular portion 14 coaxially extending from a lower face of a washer 11. Washer 11 includes an annular convex upper face 12. A work piece 50 is made with an eye 51. In use, tubular portion 14 is inserted through eye 51, and washer 11 is laid on an upper face of the work piece 50. Positioning rod 22 is inserted through tubular portion 14, thereby abutting a free end of tubular portion 14 against annular concave face 211. Annular concave face 32 of presser 30 is brought into contact with annular convex upper face 12 of washer 11. Presser 30 is moved toward mold 20 to further about the free end of tubular portion 14 against annular concave face 211 so that the free end of tubular portion 14 is expanded, enlarged and abutted against a lower face of work piece 50. Thus, eyelet 10 is finished.

As disclosed in Taiwanese Patent No. M481257, an eyelet machine is used to make an eyelet that includes two washers. The first washer includes a tubular portion. To make the eyelet, a free end of the tubular portion is inserted through the second washer before the free end of the tubular portion is enlarged in a proper manner. The eyelet machine includes two handles 1 and 2 pivotally connected to each other by a pin 3. A mold 4 is connected to handle 1. Mold 4 includes an aperture 40.

Another mold 5 is connected to handle 2. Mold 5 includes a rod 50. In operation, the tubular portion of the first washer of the eyelet is inserted through an eye made in a work piece, and the first washer of the eyelet is laid on an upper face of the work piece. The first washer is in contact with mold 4 around aperture 40. The second washer is in contact with mold 5 around rod 50. Handles 1 and 2 are closed to move molds 4 and 5 toward each other. Thus, a free end of the tubular portion of the first washer of the eyelet is brought into contact with an annular concave face of mold 5, and finally expanded, enlarged and abutted against a lower face of the work piece.

The present invention is therefore intended to obviate or at least alleviate the problems encountered in prior art.

### SUMMARY OF INVENTION

It is an objective of the present invention to provide an effective eyelet machine.

It is another objective of the present invention to provide an eyelet machine that can be held by a hand or attached to a table.

To achieve the foregoing objectives, the eyelet machine includes a frame, a lower mold, a threaded rod, an upper mold and a bearing assembly. The frame includes a lower beam, an upper beam, and a post formed between the lower and upper beams. The lower mold is adapted for carrying a first washer of an eyelet and supported on the lower beam in a detachable manner. The threaded rod is connected to the upper beam so that the threaded rod is translatable relative to the upper beam when they are rotated relative to each other. The upper mold is adapted for carrying a second washer of the eyelet and connected to the threaded rod in a detachable manner so that they are translatable together. The bearing assembly is provided between the threaded rod and the upper mold and adapted for taking a load along an axis of the threaded rod.

Other objectives, advantages and features of the present invention will be apparent from the following description referring to the attached drawings.

### BRIEF DESCRIPTION OF DRAWINGS

The present invention will be described via detailed illustration of four embodiments referring to the drawings wherein:

FIG. 1 is a perspective view of an eyelet machine according to the first embodiment of the present invention;

FIG. 2 is a top view of the eyelet machine shown in FIG. 1;

FIG. 3 is a cross-sectional view of the eyelet machine taken along a line A-A shown in FIG. 2;

FIG. 4 is a cross-sectional view of the eyelet machine taken along a line B-B shown in FIG. 2;

FIG. 5 is an enlarged, partial and exploded view of the eyelet machine shown in FIG. 1;

FIG. 6 is another enlarged, partial and exploded view of an eyelet machine shown in FIG. 1;

FIG. 7 is an enlarged, partial and exploded view of an eyelet machine according to the second embodiment of the present invention;

FIG. 8 is an enlarged, partial and exploded view of an eyelet machine according to the third embodiment of the present invention;

FIG. 9 is an enlarged, partial and exploded view of an eyelet machine according to the fourth embodiment of the present invention;

FIG. 10 is an enlarged, partial and cross-sectional view of the eyelet shown in FIG. 9; and

FIG. 11 is an enlarged, partial and cross-sectional view of the eyelet machine in another position than shown in FIG. 3.

### DETAILED DESCRIPTION OF EMBODIMENTS

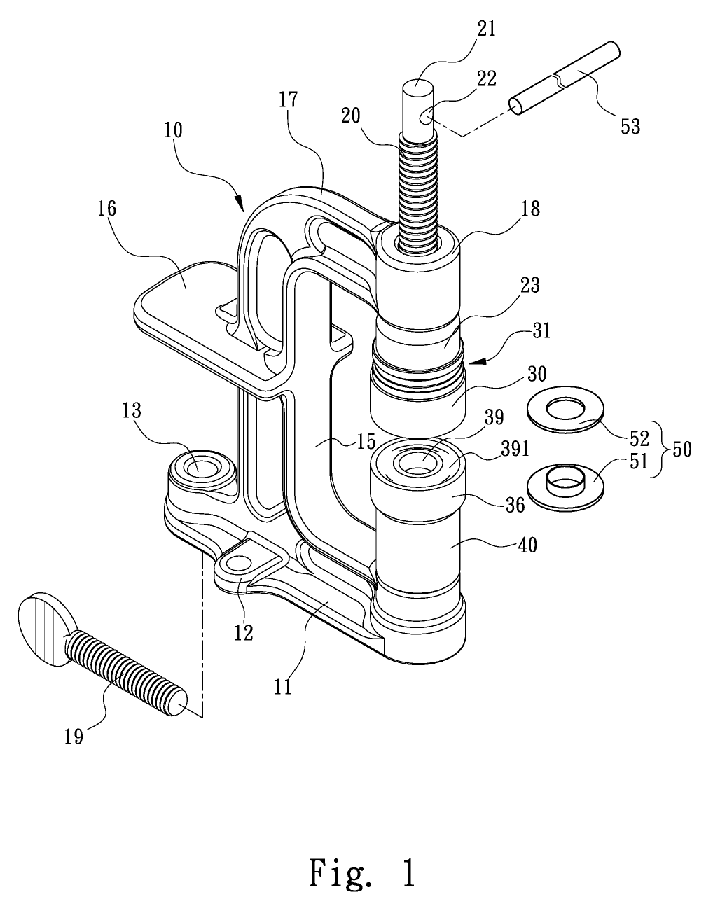

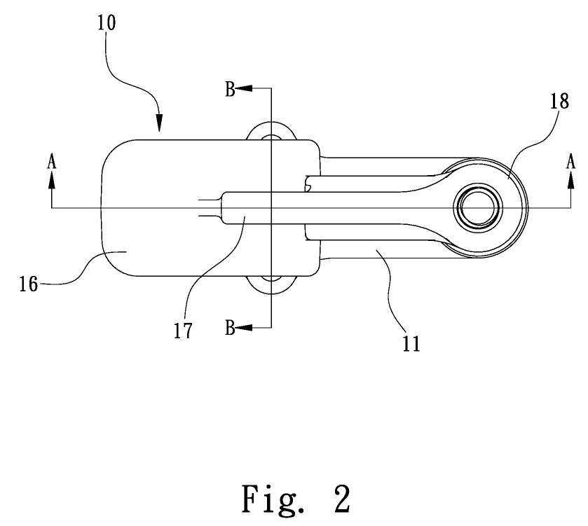

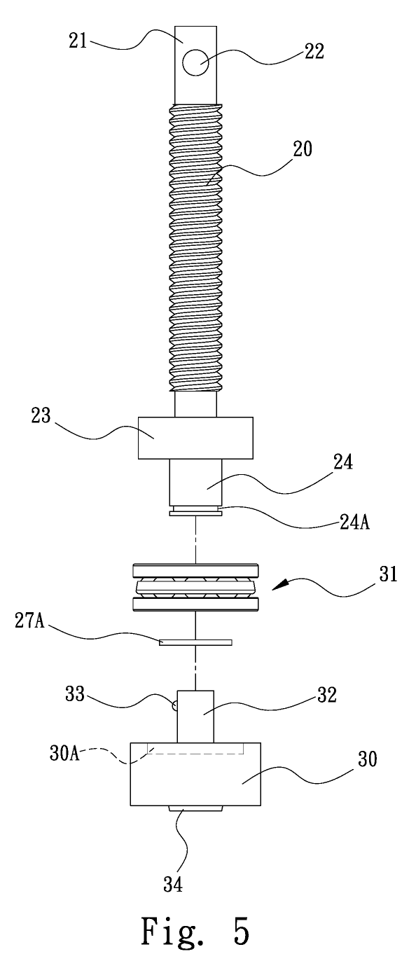

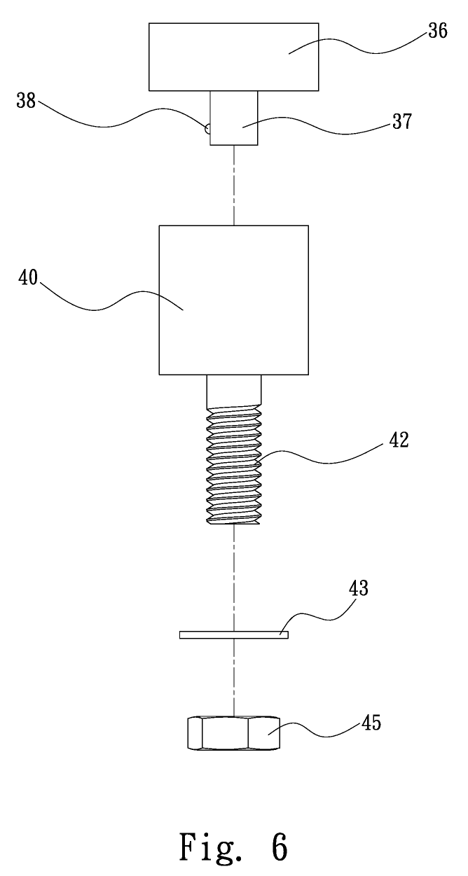

Referring to FIGS. 1 through 6, an eyelet machine includes a frame 10, a threaded rod 20, an upper mold 30, a bearing assembly, a lower mold 36 and a mold holder 40 according to a first embodiment of the present invention. The eyelet machine is used to make an eyelet 50 that includes two washers 51 and 52. Washer 51 includes a tubular portion (not numbered).

Frame 10 is a substantially C-shaped element that includes a lower beam 11, a post 15 and an upper beam 17. Lower beam 11 extends substantially parallel to upper beam 17. Post 15 is formed between lower beam 11 and upper beam 17. Post 15 can be used as handle to be held by a hand of a user.

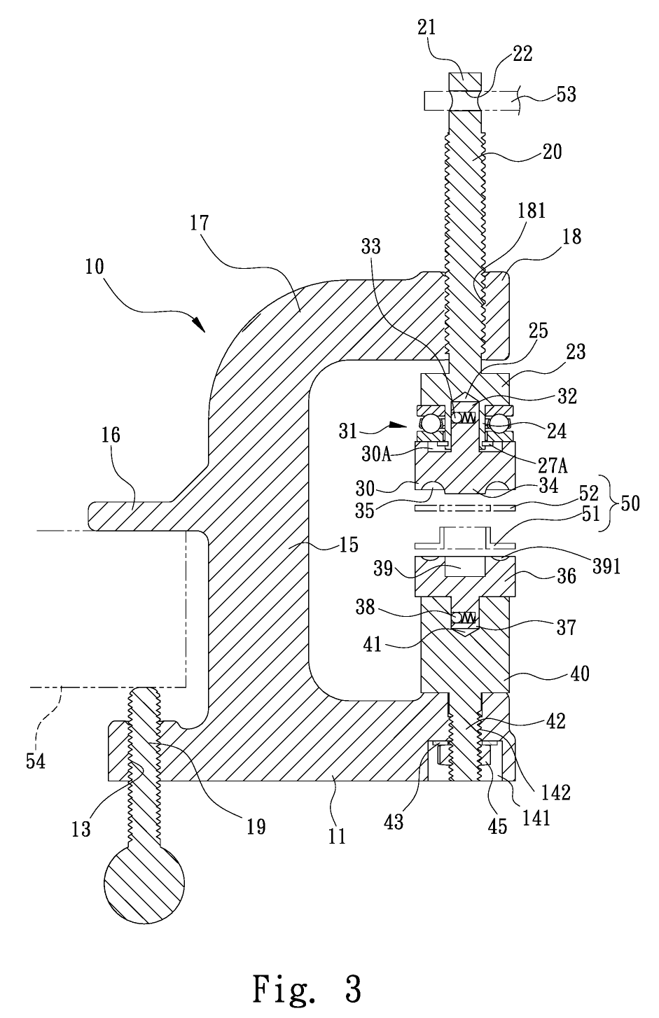

Referring to FIG. 3, lower beam 11 includes a front section located on a side of post 15 and a rear section on another side of post 15. Lower beam 11 includes two lugs 12 formed on two opposite sides, a screw hole 13 made in the rear section, a chamber 141 made in the front section, and a bore 142 in communication with chamber 141.

Post 15 includes a plate 16 formed on a rear face thereof. Plate 16 extends transversely parallel to the rear section of lower beam 11.

Upper beam 17 includes a ring 18 formed at a free end thereof. Ring 18 includes a screw hole 181.

Threaded rod 20 includes a tool-connecting portion 21 formed at an upper end thereof, a cap 24 formed at a lower end thereof, and a limiting portion 23 formed near the cap 24. Tool-connecting portion 21 includes an aperture 22. An axis of aperture 22 extends perpendicular to that of threaded rod 22 in this embodiment. Cap 24 includes a space 25 that includes an open lower end.

Upper mold 30 includes an insert 32 formed on an upper face (or “end”) thereof, an annular groove 30A in the upper face thereof, a presser 34 extending from a lower face (or “end”) thereof, and an annular concave face 35 on the lower face thereof. Annular groove 30A extends around insert 32. Annular concave face 35 extends around presser 34.

Insert 32 is provided with an elastic locking unit 33. Elastic locking unit 33 includes a ball (not numbered) biased by a spring (not numbered) in this embodiment. The spring is completely inserted in a recess (not numbered) made in insert 32. The ball is partially inserted in the recess of insert 32. However, elastic locking unit 33 can include an elastic loop partially inserted in an annular groove made in insert 32 in another embodiment.

The bearing assembly includes a thrust ball bearing 31 and a C-clip 27A.

Lower mold 36 includes a cavity 39 made in an upper face thereof, an annular concave face 391 formed on the upper face thereof, and an insert 37 formed on a lower face thereof. Annular concave face 391 extends around cavity 39.

Insert 37 is provided with an elastic locking unit 38. Elastic locking unit 38 includes a ball (not numbered) biased by a spring (not numbered) in this embodiment. The spring of elastic locking unit 38 is completely inserted in a recess (not numbered) made in insert 37. The ball of elastic locking unit 38 is partially inserted in the recess of insert 37. However, elastic locking unit 38 can include an elastic annular element partially inserted in an annular groove made in insert 37 in another embodiment.

Mold holder 40 includes a cavity 41 made in an upper face thereof and a threaded bolt 42 formed on a lower face thereof.

In assembly, threaded bolt 42 is inserted through bore 142 before threaded bolt 42 is inserted through a washer 43 and engaged with a nut 45 inserted in chamber 141. Thus, mold holder 40 is connected to the front section of lower beam 11.

Insert 37 is inserted in cavity 41. Elastic locking unit 38 keeps insert 37 in cavity 41. Hence, lower mold 36 is kept on mold holder 40.

Thrust ball bearing 31 is provided around cap before an internal portion of C-clip 27A is inserted in an annular groove 24A made in on external face of cap 24. Thrust ball bearing 31 is in contact with and hence supported on an external portion of C-clip 27A. The bearing assembly is kept around cap 24.

Insert 32 is inserted in space 25. Elastic locking unit 33 keeps insert 32 in space 25. The upper face of upper mold 30 is in contact with a lower portion of thrust ball bearing 31.

Threaded rod 20 is inserted through screw hole 181 before a tool 53 such as a bar is inserted through aperture 22. The bar can be operated to rotate threaded rod 20 relative to ring 18 in a first sense of direction to move upper mold 30 toward lower mold 36. The bar can be operated to rotate threaded rod 20 relative to ring 18 in a second sense of direction to move upper mold 30 from lower mold 36. Limiting portion 23 is used to abut against ring 18 to limit the movement of upper mold 30 from lower mold 36 so that the bearing assembly and upper mold 30 cannot and will not be detached from threaded rod 20 by mistake.

Referring to FIGS. 1 and 3, in operation, washer 52 is provided around presser 34 of upper mold 30 and in contact with annular concave face 35 of upper mold 30. Washer 51 is brought into contact with annular concave face 391 of lower mold 36. The tubular portion of washer 51 is inserted through an aperture made in a sheet (not shown) made of canvas, cloth, paper or the like. Then, presser 34 is moved downward to a free end of the tubular portion of washer 51.

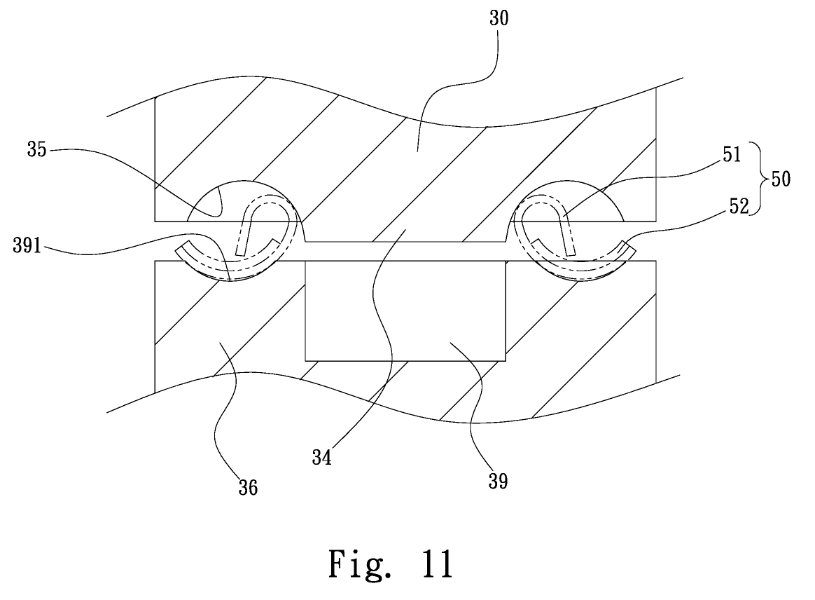

Referring to FIGS. 1 and 11, presser 34 is further moved downward to expand and enlarge the free end of the tubular portion of washer 51. Eventually, the free end of the tubular portion of washer 51 is abutted against an upper face of the washer 52. Thus, washer 52 is in tight contact with an upper face of the sheet while washer 51 is in tight contact with a lower face of the sheet.

Referring to FIGS. 1 and 3, the eyelet machine can be supported on a table 54 for example. A portion of table 54 is located between the rear section of lower beam 11 and plate 16. Another screw 19 is inserted through screw hole 13. Thus, an upper end of screw 19 can be tightly abutted against a lower face of table 54 while plate 16 is in tight contact with an upper face of table 54.

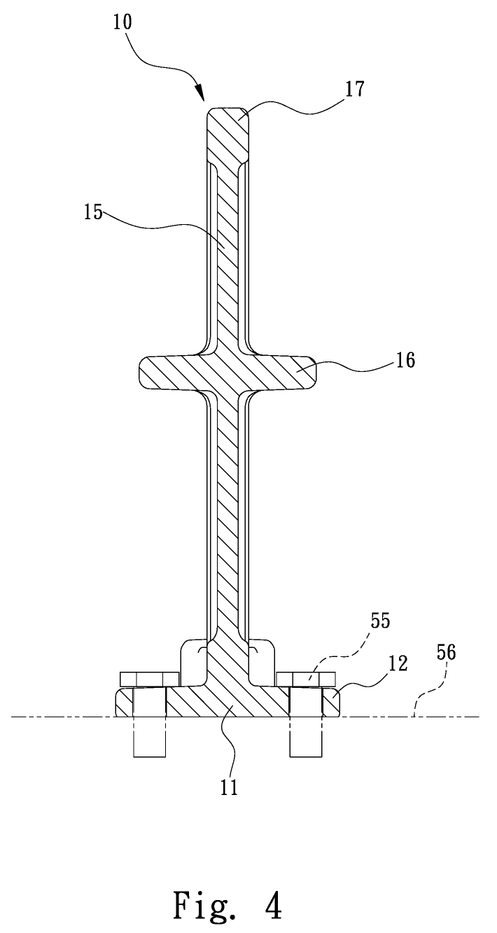

Referring to FIGS. 1 and 4, the eyelet machine can be supported on a floor 56 for example. Two screws 55 are inserted through lugs 12 before they are inserted in screw holes made in floor 56 or engaged with nuts embedded in floor 56.

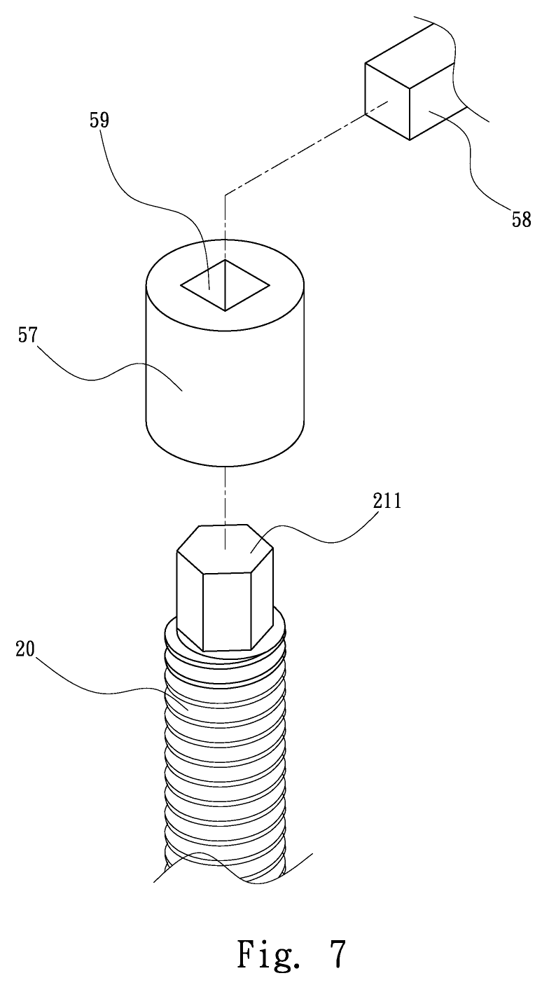

Referring to FIG. 7, there is an eyelet machine according to a second embodiment of the present invention. The second embodiment is like the first embodiment except that threaded rod 20 includes a hexagonal tool-connecting portion 211 instead of tool-connecting portion 21, which includes an aperture 22. Hexagonal tool-connecting portion 211 can be inserted in a hexagonal space (not shown) made in an end of a socket 57. Socket 57 includes, in another end, a square cavity 59 for receiving a square portion of a tool 58. Hence, tool 58 is operable to rotate threaded rod 20 via socket 57. Tool 58 can be a manual, pneumatic or electric tool. An array of pneumatic or electric tools can be used to drive an array of eyelet machines. Thus, an array of eyelets 50 can be connected to a sheet.

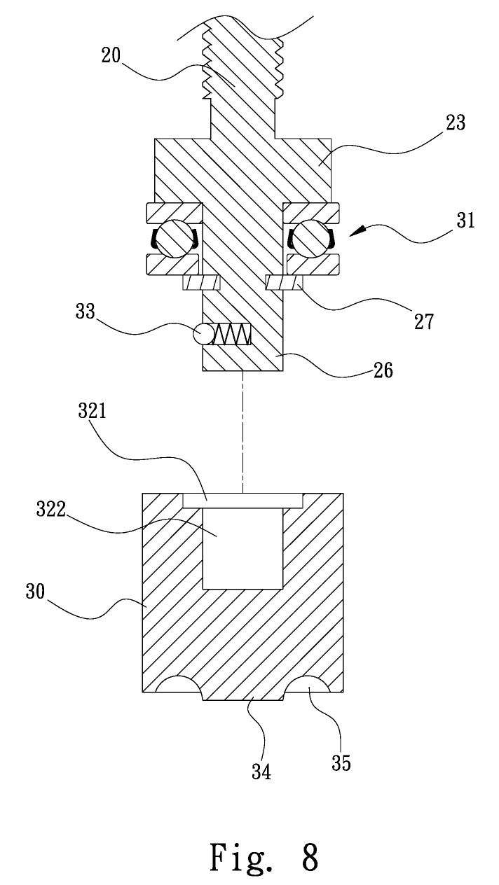

Referring to FIG. 8, there is an eyelet machine according to a third embodiment of the present invention. The third embodiment is like the first embodiment except for two things. Firstly, threaded rod 20 includes an insert 26 instead of cap 24. Thrust ball bearing 31 is provided around insert 26. A C-clip 27 includes an internal portion inserted in an annular groove made in insert 26 and an external portion in contact with thrust ball bearing 31. Insert 26 is provided with an elastic locking unit 33. Secondly, upper mold 30 includes cavities 321 and 322 instead of insert 32. A lower end of insert 26 is inserted in cavity 322 while C-clip 27 is inserted in cavity 321. Elastic locking unit 33 retains insert 26 in upper mold 30.

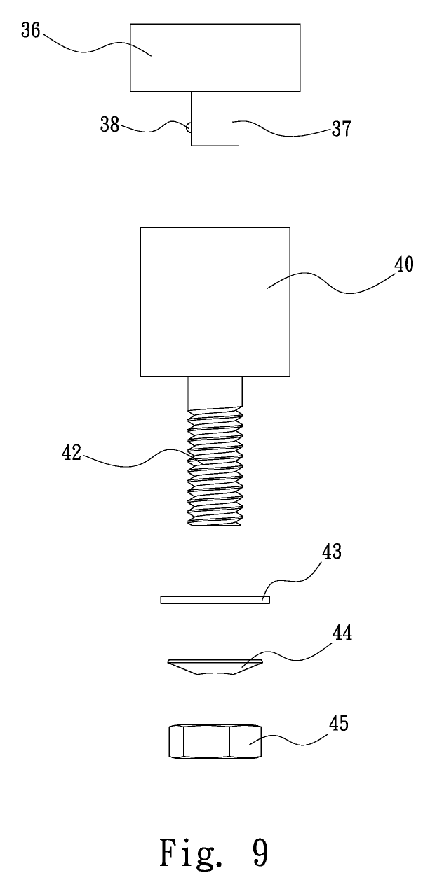

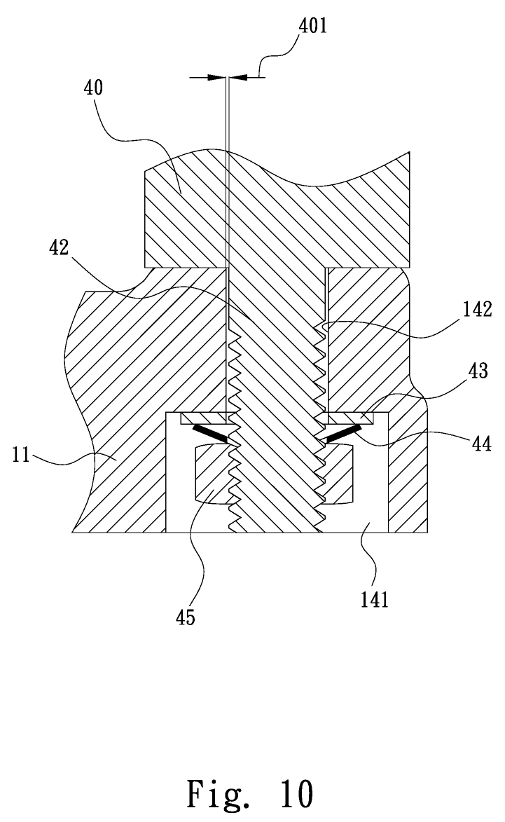

Referring to FIGS. 9 and 10, there is an eyelet machine according to a fourth embodiment of the present invention. The fourth embodiment is like the first embodiment except for including a disc-shaped spring 44 in addition. Disc-shaped spring 44 is provided around threaded bolt 42 and sandwiched between washer 43 and nut 45. Thus, lower mold 36 is kept firmly on lower beam 11. There is a gap 401 between the periphery of threaded bolt 42 and a wall of bore 142. Gap 401 allows upper mold 30 to align with lower mold 36 even if threaded bolt 42 is biased relative to lower beam 11 when upper mold 30 hits lower mold 36. Disc-shaped spring 44 is deformed when threaded bolt 42 is biased relative to lower beam 11. Disc-shaped spring 44 will recover from the deformation to return mold holder 40 and lower mold 36 to normal positions when upper mold 30 is removed from lower mold 36.

The present invention has been described via the illustration of the embodiments. Those skilled in the art can derive variations from the embodiments without departing from the scope of the present invention. Therefore, the embodiments shall not limit the scope of the present invention defined in the claims.

1. An eyelet machine comprising:
a frame comprising a lower beam, an upper beam, and a post formed between the lower and upper beams;
a lower mold adapted for carrying a first washer of an eyelet and supported on the lower beam in a detachable manner;
a threaded rod connected to the upper beam so that the threaded rod is translatable relative to the upper beam when they are rotated relative to each other;
an upper mold adapted for carrying a second washer of the eyelet and connected to the threaded rod in a detachable manner so that they are translatable together; and
a bearing assembly provided between the threaded rod and the upper mold, and adapted for taking a load along an axis of the threaded rod.

2. The eyelet machine according to claim 1, wherein the upper beam comprises ring engaged with the threaded rod, and the threaded rod comprises a limiting portion formed thereon and adapted for contact with the ring to limit upward translation of the threaded rod relative to the upper beam.

3. The eyelet machine according to claim 2, wherein the bearing assembly is provided between the limiting portion and the upper mold.

4. The eyelet machine according to claim 2, wherein the threaded rod comprises a cap extending from the limiting portion, and the lower mold comprises an insert inserted in the cap.

5. The eyelet machine according to claim 4, wherein the upper mold further comprises an elastic locking unit for contact with an internal face of the cap, thereby keeping the upper mold connected to the threaded rod.

6. The eyelet machine according to claim 4, wherein the bearing assembly is provided around the cap and between the limiting portion and the upper mold.

7. The eyelet machine according to claim 6, wherein the bearing assembly comprises a C-clip engaged with the cup and a bearing supported on the C-clip.

8. The eyelet machine according to claim 2, wherein the threaded rod comprises an insert from the limiting portion, and the upper mold comprises a cavity for receiving the insert.

9. The eyelet machine according to claim 8, wherein the insert further comprises an elastic locking unit for contact with a wall of the cavity, thereby keeping the upper mold connected to the threaded rod.

10. The eyelet machine according to claim 8, wherein the bearing assembly is provided around the insert and between the limiting portion and the upper mold.

11. The eyelet machine according to claim 10, wherein the bearing assembly comprises a C-clip engaged with the insert and a bearing supported on the C-clip.

12. The eyelet machine according to claim 1, wherein the threaded rod comprises a tool-connecting portion and an aperture made in the tool-connecting portion and adapted for receiving a tool operable to rotate the threaded rod relative to the upper beam.

13. The eyelet machine according to claim 1, wherein the threaded rod comprises a polygonal tool-connecting portion for insertion in a socket of a tool.

14. The eyelet machine according to claim 1, further comprising a mold holder between the lower beam and the lower mold.

15. The eyelet machine according to claim 14, wherein the lower beam comprises a chamber and a bore in communication with the chamber, and the mold holder comprises a threaded bolt inserted in the chamber through the bore and engaged with a nut inserted in the chamber.

16. The eyelet machine according to claim 15, further comprising a disc-shaped spring provided around the threaded bolt and between the lower beam and the nut.

17. The eyelet machine according to claim 14, wherein the mold holder comprises a cavity, and the lower mold comprises an insert inserted in the cavity.

18. The eyelet machine according to claim 17, wherein the insert comprises an elastic locking unit for abutment against a wall of the cavity to keep the lower mold on the mold holder.

19. The eyelet machine according to claim 1, wherein the lower beam comprises two lugs for receiving two screws.

20. The eyelet machine according to claim 1, wherein the frame further comprises a plate formed on the post, and the lower beam comprises a screw hole and a screw inserted in the screw hole and rotatable to press a table against the plate.
